(19) United States
(12) Patent Application Publication
(10) Pub. No.: US 2026/0155608 A1
(43) Pub. Date: Jun. 4, 2026

(54) ELECTRICAL CONNECTOR WITH IMPROVED GROUNDING STRUCTURE

(71) Applicant: DONGGUAN LUXSHARE TECHNOLOGIES CO., LTD, Dongguan City (CN)

(72) Inventors: Xiaoping WU, Dongguan City (CN); Li FAN, Dongguan City (CN); Biao HUANG, Dongguan City (CN)

(73) Assignee: DONGGUAN LUXSHARE TECHNOLOGIES CO., LTD, Dongguan City (CN)

(21) Appl. No.: 19/241,052

(22) Filed: Jun. 17, 2025

(30) Foreign Application Priority Data
Nov. 29, 2024 (CN) 202411747058.2

(51) Int. Cl. H01R 13/6581

(52) U.S. Cl. CPC H01R 13/6581

(57) ABSTRACT

An electrical connector includes an insulating body, a first ground plate and a first terminal module. The insulating body includes a receiving slot configured to receive a mating module. The first terminal module includes a number of first signal terminals and a first ground piece. The first ground piece includes a first base portion, a number of first ground terminals extending from the first base portion, and a first ground protruding portion extending from the first base portion. Each of the first signal terminals and the first ground terminals includes a first elastic arm. The first elastic arm includes a first contact portion protruding into the receiving slot to be in electrical contact with the mating module. The first ground protruding portion is in contact with the first ground plate to improve the grounding effect.

### CROSS-REFERENCE TO RELATED APPLICATION

This patent application claims priority of a Chinese Patent Application No. 202411747058.2, filed on Nov. 29, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

Electrical connectors in the related art usually include an insulating body, a plurality of conductive terminals and a ground shielding piece. The conductive terminals include a plurality of signal terminals and a plurality of ground terminals. The ground shielding piece is usually in contact with the ground terminals in order to improve the quality of signal transmission.

However, as the requirements for output transmission quality continue to increase, there is still room for improvement in the grounding effect in related technologies.

### SUMMARY

An object of the present disclosure is to provide an improved electrical connector.

The present disclosure adopts the following technical solution: an electrical connector, including: an insulating body, the insulating body defining a receiving slot configured to receive a mating module, the receiving slot extending along a first direction; a first ground plate, the first ground plate being mounted to the insulating body; and a first terminal module, the first terminal module including a plurality of first signal terminals and a first ground piece, the first ground piece including a first base portion, a plurality of first ground terminals extending from the first base portion, and a first ground protruding portion, each of the first signal terminals and the first ground terminals including a first elastic arm, the first elastic arm being provided with a first contact portion protruding into the receiving slot, the first contact portion being configured to be in electrical contact with the mating module; wherein the first ground protruding portion is in contact with the first ground plate.

The present disclosure also adopts the following technical solution: an electrical connector, including: an insulating body, the insulating body defining a receiving slot which extends along a first direction and is configured to receive a mating module; a first ground plate, the first ground plate including a first plate portion fixed in the insulating body and at least one first mounting foot extending beyond the insulating body, the at least one first mounting foot being configured to be mounted to a circuit board; and a first terminal module, the first terminal module including a plurality of first signal terminals and a first ground piece, the first ground piece including a first base portion, a first ground protruding portion and a plurality of first ground terminals extending from the first base portion; each of the first signal terminals and the first ground terminals including a first elastic arm, the first elastic arm being provided with a first contact portion protruding into the receiving slot to be in electrical contact with the mating module; wherein the first ground protruding portion elastically abuts against the first ground plate.

### BRIEF DESCRIPTION OF DRAWINGS

FIG. 1 is a schematic perspective view of an electrical connector in accordance with an embodiment of the present disclosure;

FIG. 2 is a perspective view of FIG. 1 from another angle;

FIG. 3 is a partially exploded perspective view of FIG. 1, in which an insulating body is separated;

FIG. 4 is a partially exploded perspective view of FIG. 3 from another angle;

FIG. 5 is a further partially exploded perspective view of FIG. 3;

FIG. 6 is a partially exploded perspective view of FIG. 5 from another angle;

FIG. 7 is a perspective view of a first terminal module, a second terminal module and a first ground plate when assembled together;

FIG. 8 is a perspective view of FIG. 7 from another angle;

FIG. 9 is a partially exploded perspective view of FIG. 7, in which the first terminal module, the second terminal module and the first ground plate are separated from one another;

FIG. 10 is a partially exploded perspective view of FIG. 9 from another angle;

FIG. 11 is a further partially exploded perspective view of FIG. 9;

FIG. 12 is a partially exploded perspective view of FIG. 11 from another angle;

FIG. 13 is an exploded perspective view of a plurality of first signal terminals, a plurality of first cables, a first ground piece, a first ground shielding piece and a second ground shielding piece in FIG. 11;

FIG. 14 is an exploded perspective view of FIG. 13 from another angle;

FIG. 15 is an exploded perspective view of a plurality of second signal terminals, a plurality of second cables, a second ground piece, a third ground shielding piece and a fourth ground shielding piece in FIG. 11;

FIG. 16 is an exploded perspective view of FIG. 15 from another angle;

FIG. 17 is an exploded perspective view of a third module;

FIG. 18 is an exploded perspective view of FIG. 17 from another angle;

FIG. 19 is a schematic cross-sectional view taken along line B-B in FIG. 1;

FIG. 20 is a partial enlarged view of frame part C in FIG. 19; and

FIG. 21 is a schematic cross-sectional view taken along line D-D in FIG. 1.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

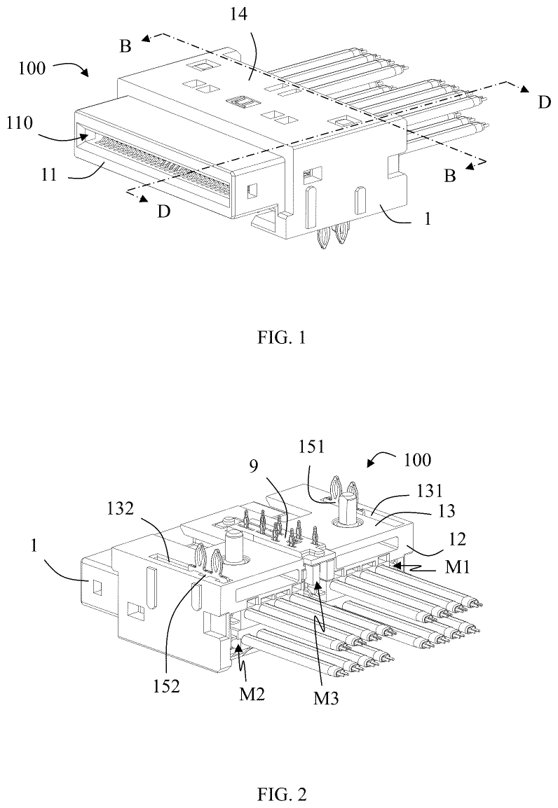

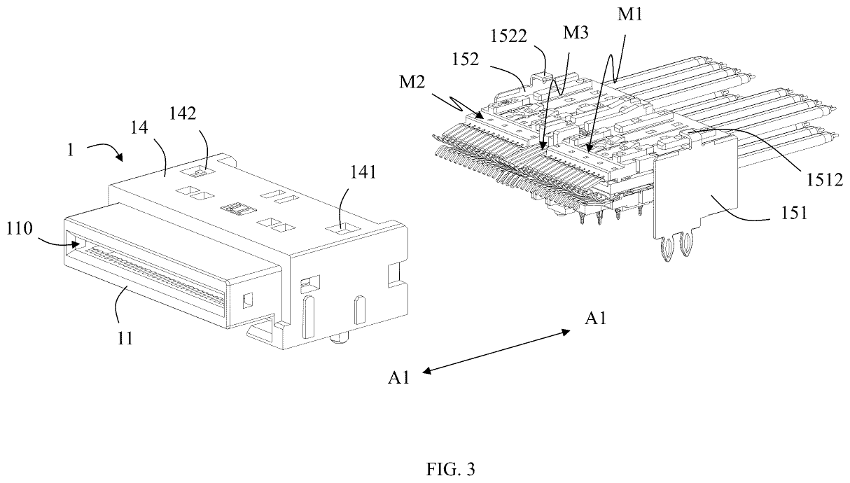

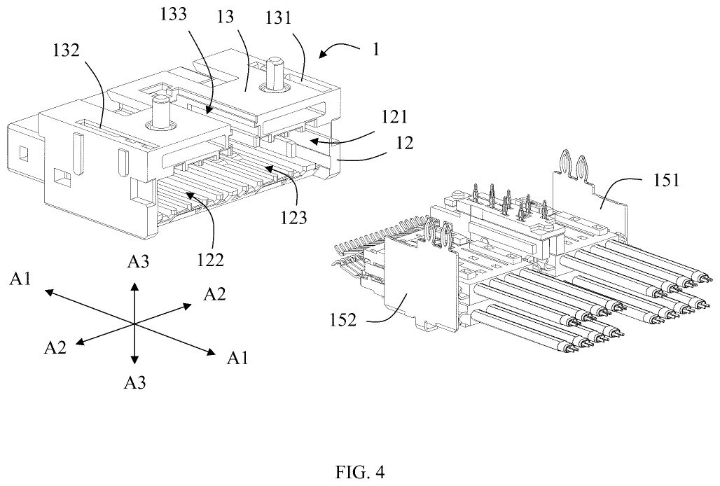

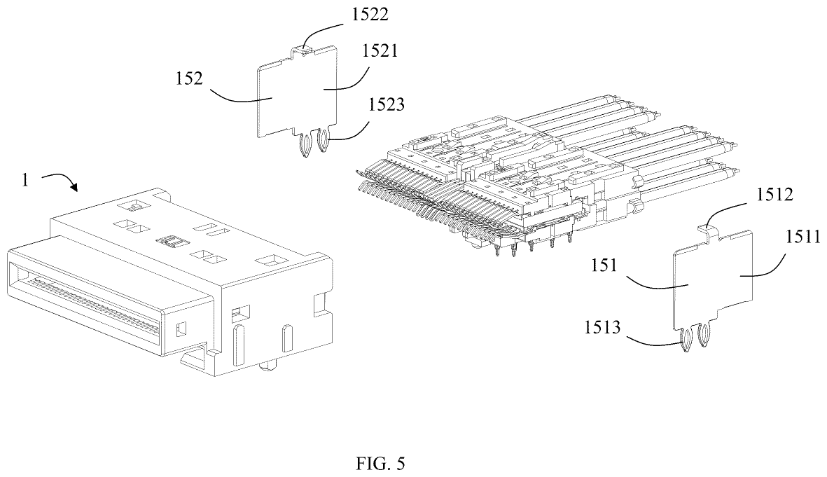

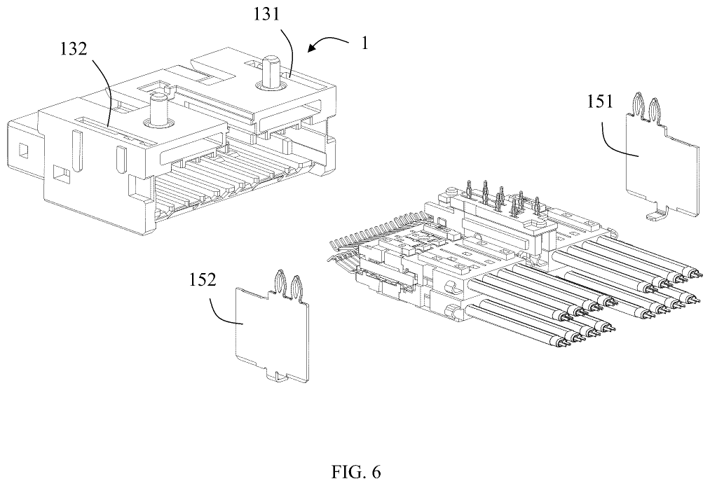

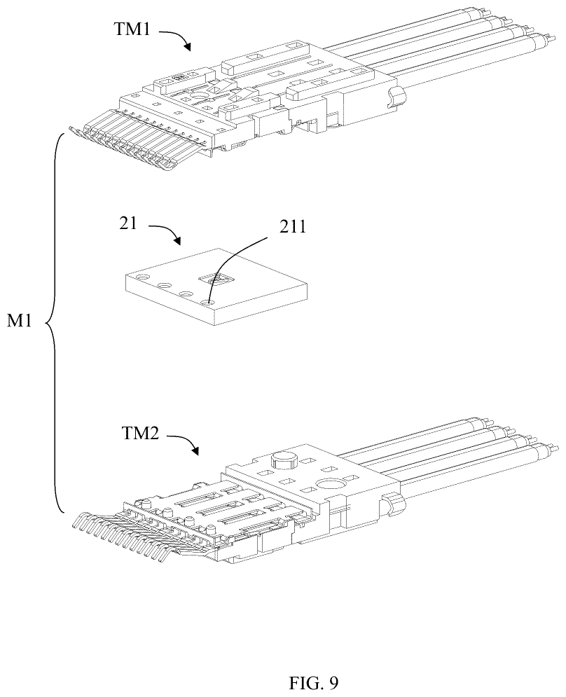

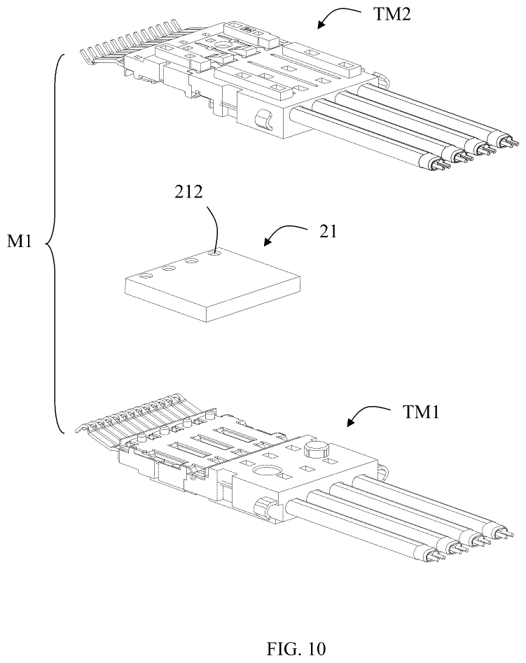

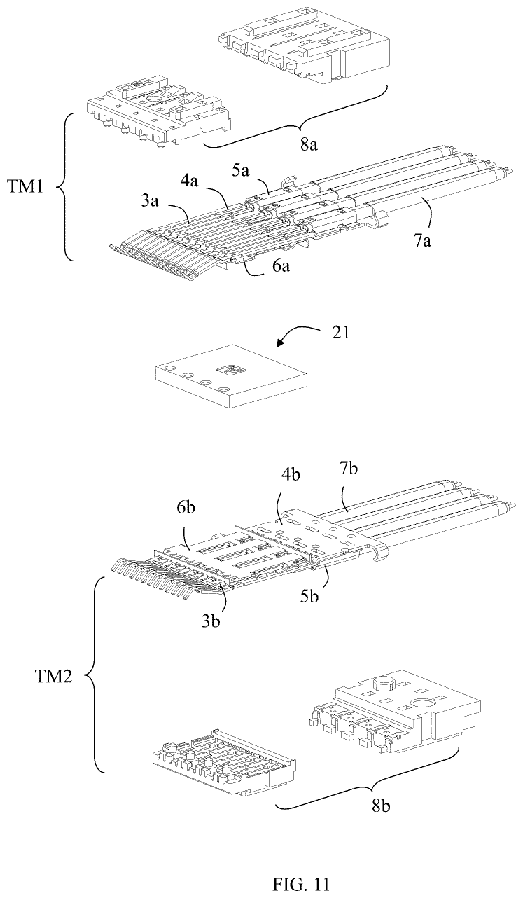

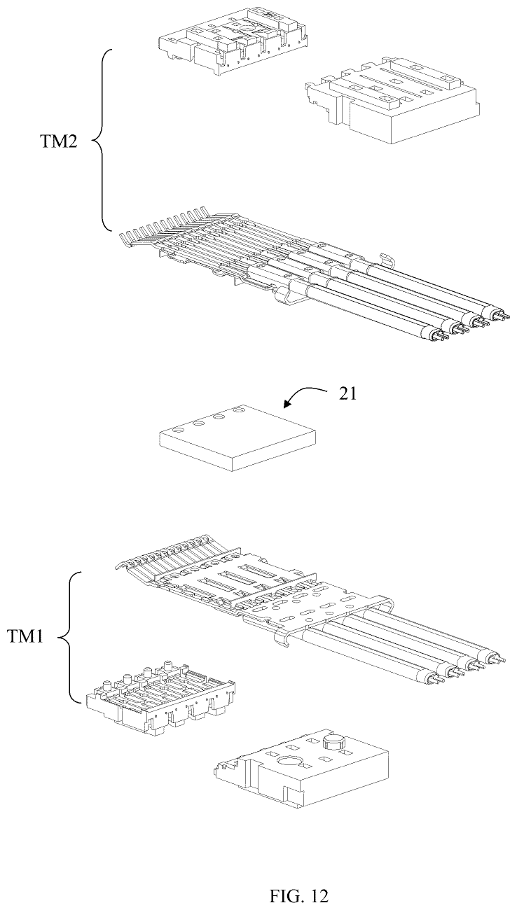

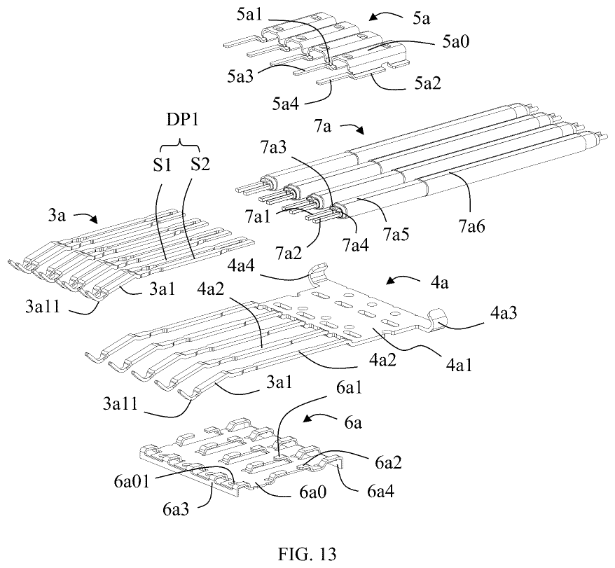

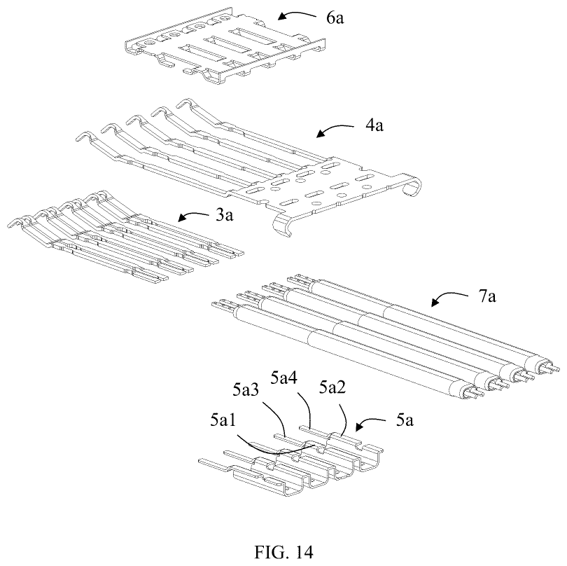

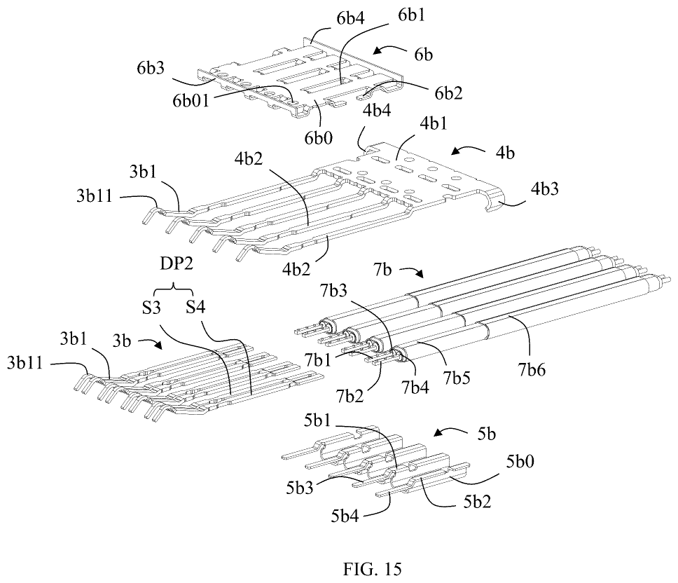

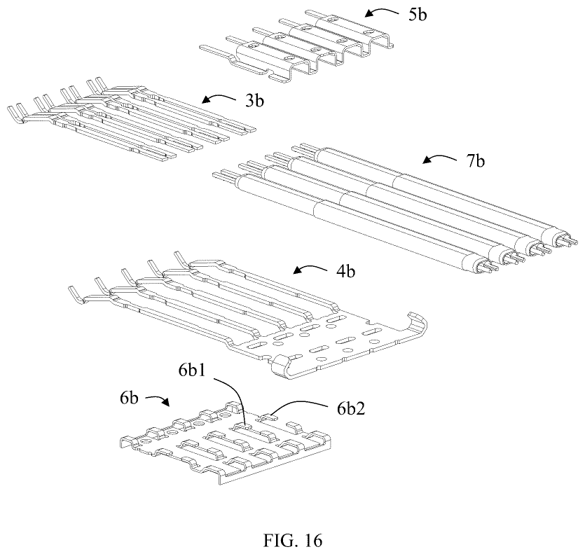

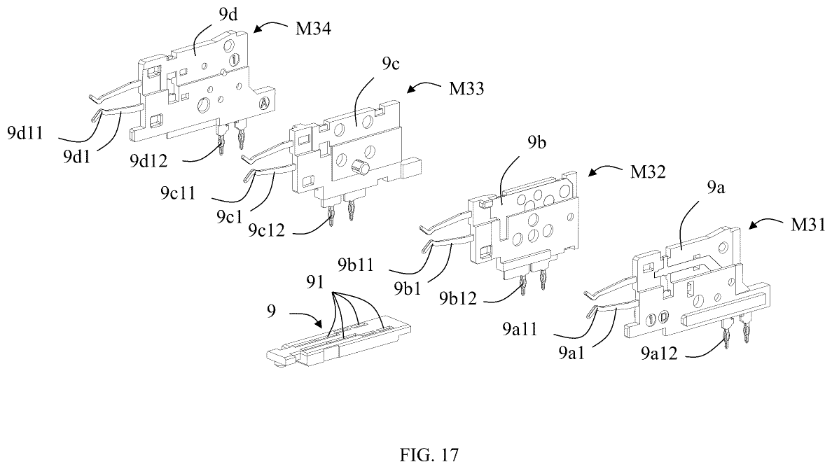

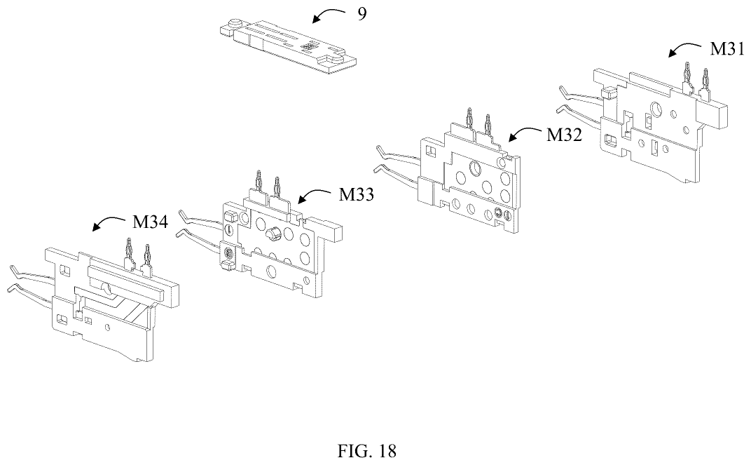

Referring to FIG. 1 to FIG. 21, the present disclosure discloses an electrical connector 100, which includes an insulating body 1, a plurality of ground plates mounted to the insulating body 1, a first module M1 mounted to the insulating body 1, a second module M2 mounted to the insulating body 1, and a third module M3 mounted to the insulating body 1.

In the illustrated embodiment of the present disclosure, the insulating body 1 includes a mating surface 11, a rear surface 12 disposed opposite to the mating surface 11 along a first direction A1-A1, a mounting surface 13 for being mounted on a circuit board (not shown), and a top surface 14 disposed opposite to the mounting surface 13 along a third direction A3-A3. The first direction A1-A1 (for example, a front-rear direction) is perpendicular to the third direction A3-A3 (for example, a top-bottom direction).

The insulating body 1 defines a receiving slot 110 that extends through the mating surface 11 and is configured to receive a mating module (not shown). The receiving slot 110 extends along the first direction A1-A1. The insulating body 1 defines a first receiving cavity 121 extending through the rear surface 12 along the first direction A1-A1, a second receiving cavity 122 extending through the rear surface 12 along the first direction A1-A1, and a third receiving cavity 123 extending through the rear surface 12 along the first direction A1-A1. The third receiving cavity 123 is located between the first receiving cavity 121 and the second receiving cavity 122 along a second direction A2-A2 (for example, a left-right direction). The third direction A3-A3 is perpendicular to the first direction A1-A1 and the second direction A2-A2. The first receiving cavity 121, the second receiving cavity 122 and the third receiving cavity 123 are all in communication with the receiving slot 110.

The insulating body 1 further includes a first mounting groove 131 extending through the mounting surface 13, a second mounting groove 132 extending through the mounting surface 13 and a third mounting groove 133 extending through the mounting surface 13. The third mounting groove 133 is located between the first mounting groove 131 and the second mounting groove 132 along the second direction A2-A2. The insulating body 1 further includes a first recess 141 extending through the top surface 14 and communicating with the first mounting groove 131, and a second recess 142 extending through the top surface 14 and communicating with the second mounting groove 132. The third mounting groove 133 is in communication with the third receiving cavity 123 along the third direction A3-A3.

The ground plates include a first ground plate 151 and a second ground plate 152. The first ground plate 151 is received in the first mounting groove 131 and the first recess 141. The second ground plate 152 is received in the second mounting groove 132 and the second recess 142. Specifically, in the illustrated embodiment of the present disclosure, the first ground plate 151 includes a first plate portion 1511 received in the first mounting groove 131, a first bent portion 1512 bent from the first plate portion 1511 and a plurality of first mounting feet 1513 extending from the first plate portion 1511. The first bent portion 1512 is received in the first recess 141 and abuts against the insulating body 1. The second ground plate 152 includes a second plate portion 1521 received in the second mounting groove 132, a second bent portion 1522 bent from the second plate portion 1521, and a plurality of second mounting feet 1523 extending from the second plate portion 1521. The second bent portion 1522 is received in the second recess 142 and abuts against the insulating body 1. The first mounting feet 1513 and the second mounting feet 1523 both extend out of the mounting surface 13 for being mounted to the circuit board. In the illustrated embodiment of the present disclosure, the first mounting feet 1513 and the second mounting feet 1523 are arranged in a staggered manner along the second direction A2-A2.

The first module M1 includes a first terminal module TM1, a second terminal module TM2 and a first ground block 21 disposed between the first terminal module TM1 and the second terminal module TM2.

The first terminal module TM1 includes a plurality of first signal terminals 3a, a first ground piece 4a, a first ground shielding piece 5a, a second ground shielding piece 6a, a plurality of first cables 7a and a first insulating block 8a.

The first ground piece 4a includes a first base portion 4a1, a plurality of first ground terminals 4a2 extending from the first base portion 4a1, a first ground protruding portion 4a3 extending from one side of the first base portion 4a1, and a third ground protruding portion 4a4 extending from another side of the first base portion 4a1. Each of the first signal terminals 3a and the first ground terminals 4a2 includes a first elastic arm 3a1. The first elastic arm 3a1 is provided with a first contact portion 3a11 that protrudes into the receiving slot 110. The first contact portion 3a11 is configured to be in electrical contact with the mating module.

The plurality of first signal terminals 3a include a first differential signal terminal S1 and a second differential signal terminal S2. The first differential signal terminal S1 and the second differential signal terminal S2 are arranged adjacent to each other and form a first differential pair DP1 in order to increase the signal transmission rate. Each of two sides of the first differential pair DP1 is provided with one first ground terminal 4a2 disposed adjacent to the first differential pair DP1 in order to improve the quality of signal transmission.

Each first cable 7a includes a first core 7a1, a second core 7a2, a first insulating portion 7a3 wrapped around the first core 7a1, a second insulating portion 7a4 wrapped around the second core 7a2, a first shielding layer 7a5 wrapped around the first insulating portion 7a3 and the second insulating portion 7a4, and a first insulating skin 7a6 located outside the first shielding layer 7a5. The first core 7a1 is electrically connected (for example, soldered or welded) to the first differential signal terminal S1. The second core 7a2 is electrically connected (for example, soldered or welded) to the second differential signal terminal S2.

The first ground shielding piece 5a includes a first shielding portion 5a0 at least partially covering the first cable 7a, a first abutting portion 5a1 extending from one side of the first shielding portion 5a0, a second abutting portion 5a2 extending from another side of the first shielding portion 5a0, a first tab portion 5a3 extending forwardly from the first abutting portion 5a1, and a second tab portion 5a4 extending forwardly from the second abutting portion 5a2.

The first abutting portion 5a1 and the second abutting portion 5a2 are both arranged to be in contact with one side surface of the first base portion 4a1. The first tab portion 5a3 and the second tab portion 5a4 are arranged to be in contact with one side of corresponding first ground terminals 4a2.

In the illustrated embodiment of the present disclosure, the first shielding portion 5a0 is in a raised shape so as to be in contact with the first shielding layer 7a5 of the first cable 7a.

The second ground shielding piece 6a includes a first body portion 6a0, a plurality of first ribs 6a1 integrally stamped from the first body portion 6a0, a plurality of second ribs 6a2 integrally stamped from the first body portion 6a0, a first bent portion 6a3 bent from one end of the first body portion 6a0, and a second bent portion 6a4 bent from another end of the first body portion 6a0. The plurality of first ribs 6a1 are spaced apart along the first direction A1-A1, and the plurality of second ribs 6a2 are spaced apart along the first direction A1-A1, thereby forming multi-point contacts with the corresponding first ground terminals 4a2. The first rib 6a1 and the second rib 6a2 are arranged to be in contact with another side of the corresponding first ground terminals 4a2.

The first insulating block 8a is at least partially fixed on the first signal terminals 3a, the first ground piece 4a and the first ground shielding piece 5a. The number of the first insulating blocks 8a may be one or several. In the illustrated embodiment of the disclosure, the first insulating block 8a is formed on the first signal terminals 3a, the first ground piece 4a and the first ground shielding piece 5a so as to be combined into a whole. The first elastic arms 3a1 of the first signal terminals 3a and the first ground terminal s4a2 both extend out of the first insulating block 8a. The first ground protruding portion 4a3 and the third ground protruding portion 4a4 both extend out of the first insulating block 8a to both sides along the second direction A2-A2. The first ground protruding portion 4a3 is in contact with the first ground plate 151. In the illustrated embodiment of the present disclosure, the first ground protruding portion 4a3 elastically abuts against the first ground plate 151.

In the illustrated embodiment of the present disclosure, the second ground shielding piece 6a is provided with a plurality of first positioning holes 6a01. The first insulating block 8a is provided with a plurality of first positioning posts 8a1 at least partially inserted into the first positioning holes 6a01. In an embodiment of the present disclosure, the first positioning posts 8a1 can also be configured to increase the bonding force with the second ground shielding piece 6a through heat melting or other methods.

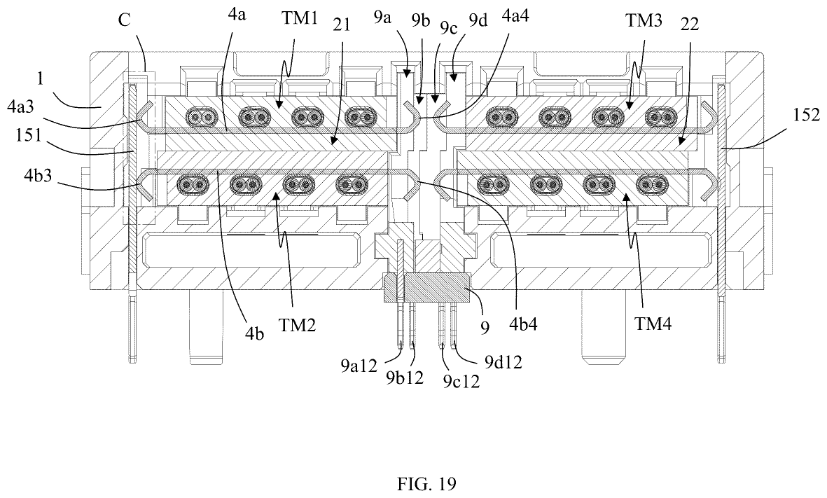

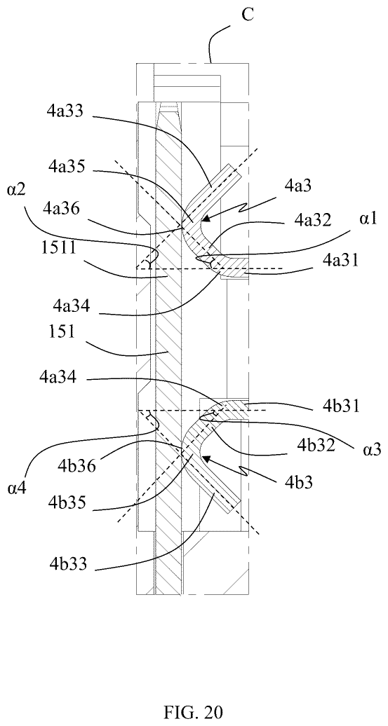

Specifically, referring to FIG. 19 and FIG. 20, in the illustrated embodiment of the present disclosure, the first ground protruding portion 4a3 is first bent laterally outward and then inwardly as a whole. Specifically, the first ground protruding portion 4a3 includes a first straight portion 4a31, a first inclined portion 4a32, a second inclined portion 4a33, a first connecting portion 4a34 connecting the first straight portion 4a31 and the first inclined portion 4a32, and a first arc-shaped portion 4a35 connecting the first inclined portion 4a32 and the second inclined portion 4a33. a first included angle α1 of 45° is formed by the first straight portion 4a31 and the first inclined portion 4a32. A second included angle α2 of 45° is formed by the first straight portion 4a31 and the second inclined portion 4a33. The first arc-shaped portion 4a35 is provided with a first arc-shaped surface 4a36 that abuts against the first plate portion 1511 of the first ground plate 151.

Similarly, the second terminal module TM2 includes a plurality of second signal terminals 3b, a second ground piece 4b, a third ground shielding piece 5b, a fourth ground shielding piece 6b, a plurality of second cables 7b and a second insulating block 8b.

The second ground piece 4b includes a second base portion 4b1, a plurality of second ground terminals 4b2 extending from the second base portion 4b1, a second ground protruding portion 4b3 extending from one side of the second base portion 4b1, and a fourth ground protruding portion 4b4 extending from another side of the second base portion 4b1. Each of the second signal terminals 3b and the second ground terminals 4b2 includes a second elastic arm 3b1. The second elastic arm 3b1 is provided with a second contact portion 3b11 protruding into the receiving slot 110. The second contact portion 3b11 is configured to be in electrical contact with the mating module. The first elastic arm 3a1 and the second elastic arm 3b1 are located on two sides of the receiving slot 110, respectively, along the third direction A3-A3 to jointly clamp the mating module, thereby improving mating reliability.

The plurality of second signal terminals 3b include a third differential signal terminal S3 and a fourth differential signal terminal S4. The third differential signal terminal S3 and the fourth differential signal terminal S4 are arranged adjacent to each other and form a second differential pair DP2 in order to increase the signal transmission rate. Each of two sides of the second differential pair DP2 is provided with one second ground terminal 4b2 disposed adjacent to the second differential pair DP2 in order to improve the quality of signal transmission.

Each second cable 7b includes a third core 7b1, a fourth core 7b2, a third insulating portion 7b3 wrapped around the third core 7b1, a fourth insulating portion 7b4 wrapped around the fourth core 7b2, a second shielding layer 765 wrapped around the third insulating portion 7b3 and the fourth insulating portion 7b4, and a second insulating skin 7b6 located outside the second shielding layer 7b5. The third core 7b 1 is electrically connected (for example, soldered or welded) to the third differential signal terminal S3. The fourth core 7b2 is electrically connected (for example, soldered or welded) to the fourth differential signal terminal S4.

The third ground shielding piece 5b includes a second shielding portion 560 at least partially covering the second cable 7b, a third abutting portion 5bl extending from one side of the second shielding portion 5b0, a fourth abutting portion 5b2 extending from another side of the second shielding portion 5b0, a third protruding piece portion 5b3 extending forwardly from the third abutting portion 5b1, and a fourth protruding piece portion 5b4 extending forwardly from the fourth abutting portion 5b2.

The third abutting portion 5b1 and the fourth abutting portion 5b2 are both arranged to contact one side surface of the second base portion 4b1. The third tab portion 5b3 and the fourth tab portion 5b4 are arranged to contact one side of corresponding second ground terminals 4b2.

In the illustrated embodiment of the present disclosure, the second shielding portion 5b0 is in a concave shape in order to be in contact with the second shielding layer 7b5 of the second cable 7b.

The fourth ground shielding piece 6b includes a second body portion 6b0, a plurality of third ribs 6b1 integrally stamped from the second body portion 6b0, a plurality of fourth ribs 6b2 integrally stamped from the second body portion 660, a third bent portion 6b3 bent from one end of the second body portion 6b0, and a fourth bent portion 6b4 bent from another end of the second body portion 6b0. The plurality of third ribs 6bl are spaced apart along the first direction A1-A1, and the plurality of fourth ribs 6b2 are spaced apart along the first direction A1-A1, thereby forming multi-point contacts with the corresponding second ground terminals 4b2. The third rib 6b1 and the fourth rib 6b2 are arranged to be in contact with another side of the corresponding second ground terminals 4b2.

The second insulating block 8b is at least partially fixed on the second signal terminals 3b, the second ground piece 4b and the third ground shielding piece 5b. The number of the second insulating blocks 8b may be one or several. In the illustrated embodiment of the present disclosure, the second insulating block 8b is formed on the second signal terminals 3b, the second ground piece 4b and the third ground shielding piece 5b to be combined into a whole. The second elastic arms 3b1 of the second signal terminals 3b and the second ground terminals 4b2 both extend out of the second insulating block 8b. The second ground protruding portion 4b3 and the fourth ground protruding portion 4b4 extend out of the second insulating block 8b to both sides along the second direction A2-A2. The second ground protruding portion 4b3 is in contact with the first ground plate 151. In the illustrated embodiment of the present disclosure, the first second protruding portion 4b3 elastically abuts against the first ground plate 151. The third ground protruding portion 4a4 and the fourth ground protruding portion 4b4 are configured to abut against the third module M3.

In the illustrated embodiment of the present disclosure, the fourth ground shielding piece 6b defines a plurality of second positioning holes 6b01. The second insulating block 8b is provided with a plurality of second positioning posts 8b1 at least partially inserted into the second positioning holes 6b01. In an embodiment of the present disclosure, the second positioning posts 8b1 can also be configured to increase the bonding force with the fourth ground shielding piece 6b through heat melting or other methods.

Specifically, as shown in FIG. 19 and FIG. 20, in the illustrated embodiment of the present disclosure, the second ground protruding portion 4b3 is first bent laterally outward and then inwardly bent as a whole. Specifically, the second ground protruding portion 4b3 includes a second straight portion 4b31, a third inclined portion 4b32, a fourth inclined portion 4b33, a second connecting portion 4b34 connecting the second straight portion 4b31 and the third inclined portion 4b32, and a second arc-shaped portion 4b35 connecting the third inclined portion 4632 and the fourth inclined portion 4b33. A third included angle α3 of 45° is formed by the second straight portion 4b31 and the third inclined portion 4b32. A fourth included angle α4 of 45° is formed by the second straight portion 4b31 and the fourth inclined portion 4b33. The second arc-shaped portion 4b35 is provided with a second arc-shaped surface 4b36 that abuts against the first plate portion 1511 of the first ground plate 151.

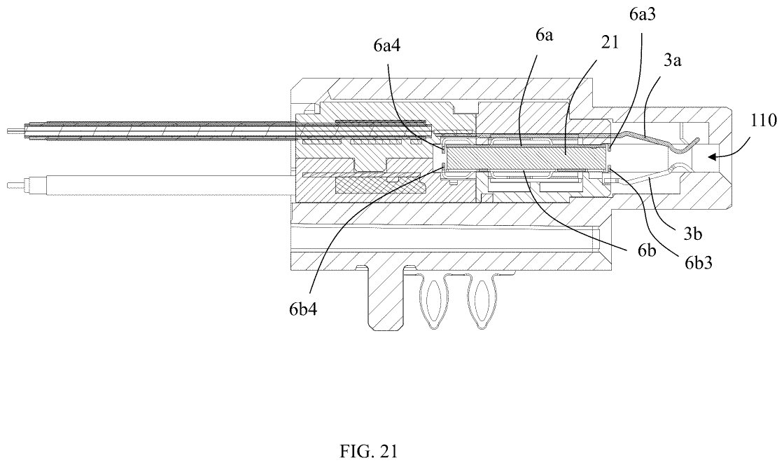

The second ground shielding piece 6a is in contact with one side of the first ground block 21. The fourth ground shielding piece 6b is in contact with another side of the first ground block 21. Such an arrangement increases the shielding area and is beneficial to improving the quality of signal transmission. In the illustrated embodiment of the present disclosure, the first ground block 21 defines a plurality of first positioning recessed holes 211 that match the first positioning posts 8a1, and a plurality of second positioning recessed holes 212 that match the second positioning posts 8b1. In an embodiment of the present disclosure, the first positioning recessed holes 211 and the second positioning recessed holes 212 are aligned along the second direction A2-A2. The first positioning recessed hole 211 and the corresponding second positioning recessed hole 212 are in communication along the second direction A2-A2. As shown in FIG. 21, the first ground block 21 is located between the first bent portion 6a3 and the second bent portion 6a4, and also located between the third bent portion 6b3 and the fourth bent portion 6b4.

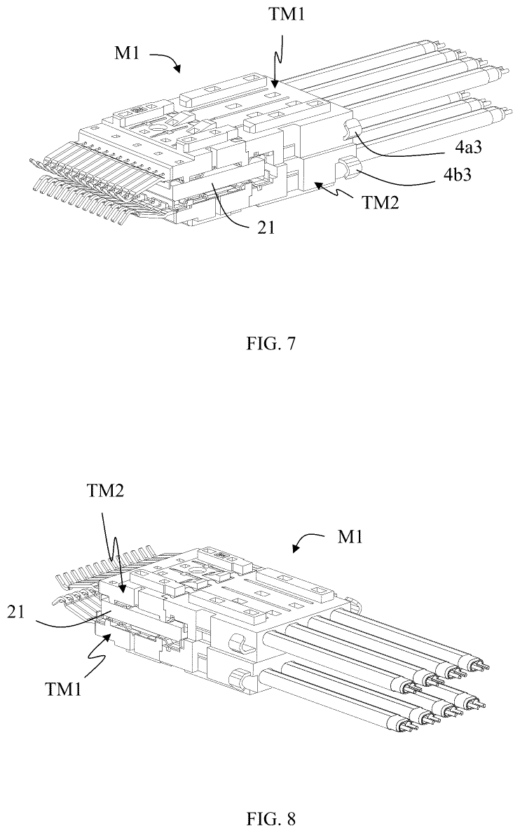

Referring to FIG. 7 and FIG. 8, in the illustrated embodiment of the present disclosure, after the first terminal module TM1, the second terminal module TM2 and the first ground block 21 are assembled into the first module M1, the first module M1 is then inserted into the first receiving cavity 121 from the rear surface 12 along the first direction A1-A1. The first ground protruding portion 4a3 and the second ground protruding portion 4b3 undergo a certain degree of elastic deformation during contact with the first ground plate 151, thereby ensuring contact reliability.

In the illustrated embodiment of the present disclosure, the first terminal module TM1 and the second terminal module TM2 are arranged in a staggered manner along the third direction A3-A3. Preferably, the first terminal module TM1 and the second terminal module TM2 are the same part with different installation angles, so as to realize parts sharing and thereby reducing costs.

The second module M2 includes a third terminal module TM3, a fourth terminal module TM4, and a second ground block 22 located between the third terminal module TM3 and the fourth terminal module TM4.

In the illustrated embodiment of the present disclosure, the first module M1 and the second module M2 are symmetrically arranged. Therefore, regarding the second module M2, reference may be made to the description of the first module M2, which will not be described again in the present disclosure.

Preferably, the first terminal module TM1, the second terminal module TM2, the third terminal module TM3 and the fourth terminal module TM4 are all the same part with different installation angles so as to realize parts sharing and thereby reducing costs. The second ground block 22 and the first ground block 21 can also be shared parts, thereby reducing costs.

In the illustrated embodiment of the present disclosure, the third module M3 includes a first terminal wafer M31, a second terminal wafer M32, a third terminal wafer M33, a fourth terminal wafer M34 and a mounting block 9.

The first terminal module M31 includes a first insulation plate 9a and a plurality of first terminals 9a1 fixed to the first insulation plate 9a. In the illustrated embodiment of the present disclosure, the first terminals 9a1 are insert-molded with the first insulation plate 9a so as to form as a whole. Each first terminal 9a1 includes a first elastic arm 9a11 protruding beyond the first insulation plate 9a and a first mounting tail 9a12 protruding beyond the first insulation plate 9a. The first mounting tail 9a12 is configured to be mounted to the circuit board.

The second terminal module M32 includes a second insulation plate 9b and a plurality of second terminals 9b1 fixed to the second insulation plate 9b. In the illustrated embodiment of the present disclosure, the second terminals 9b1 are insert-molded with the second insulation plate 9b so as to form as a whole. Each second terminal 9b1 includes a second elastic arm 9b11 protruding beyond the second insulation plate 9b and a second mounting tail 9b 12 protruding beyond the second insulation plate 9b. The second mounting tail 9b 12 is configured to be mounted to the circuit board.

The third terminal module M33 includes a third insulation plate 9c and a plurality of third terminals 9c1 fixed to the third insulation plate 9c. In the illustrated embodiment of the present disclosure, the third terminals 9c1 are insert-molded with the third insulation plate 9c so as to form as a whole. Each third terminal 9c1 includes a third elastic arm 9c11 protruding beyond the third insulation plate 9c and a third mounting tail 9c12 protruding beyond the third insulation plate 9c. The third mounting tail 9c12 is configured to be mounted to the circuit board.

The fourth terminal module M34 includes a fourth insulation plate 9d and a plurality of fourth terminals 9d1 fixed to the fourth insulation plate 9d. In the illustrated embodiment of the present disclosure, the fourth terminals 9d1 are insert-molded with the fourth insulation plate 9d so as to form as a whole. Each fourth terminal 9d1 includes a fourth elastic arm 9d11 protruding beyond the fourth insulation plate 9d and a fourth mounting tail 9d12 protruding beyond the fourth insulation plate 9d. The fourth mounting tail 9d12 is configured to be mounted to the circuit board.

The mounting block 9 defines a plurality of mounting slots 91 to allow the first mounting tails 9a12, the second mounting tails 9b12, the third mounting tails 9c12 and the fourth mounting tails 9d12 to pass through. The functions of the first terminals 9a1, the second terminals 9b1, the third terminals 9c1 and the fourth terminals 9d1 can be flexibly determined according to needs, including but not limited to, for transmitting power or signal (for example, low-speed signal).

In an embodiment of the present disclosure, in order to adapt to the staggered arrangement of the first terminal module TM1 and the second terminal module TM2, and the staggered arrangement of the third terminal module TM3 and the fourth terminal module TM4, the first elastic arm 9a11, the second elastic arm 9b 11, the third elastic arm 9c11 and the fourth elastic arm 9d11 which are located on a same side (for example, an upper side) of the first terminal 9a1, the second terminal 9b1, the third terminal 9c1 and the fourth terminal 9d1 may also be designed to deviate to a same side (for example, to the left) along the second direction A2-A2. The first elastic arm 9a11, the second elastic arm 9b11, the third elastic arm 9c11 and the fourth elastic arm 9d11 which are located on another same side (for example, a lower side) of the first terminal 9a1, the second terminal 9b1, the third terminal 9c1 and the fourth terminal 9d1 may also be designed to deviate to another same side (for example, to the right) along the second direction A2-A2. With this arrangement, it is able to optimize the spacing among the first terminal 9a1, the second terminal 9b1, the third terminal 9c1 and the fourth terminal 9d1 along the second direction A2-A2.

In the illustrated embodiment of the present disclosure, the first terminal module M31, the second terminal module M32, the third terminal module M33 and the fourth terminal module M34 are firstly assembled into a whole, and then inserted into the third receiving cavity 123 from the rear surface 12. The first insulation plate 9a, the second insulation plate 9b, the third insulation plate 9c and the fourth insulation plate 9d are provided with mutually matching installation structures, such as protrusions and grooves, or positioning posts and positioning holes, etc.

After the first terminal module M31, the second terminal module M32, the third terminal module M33 and the fourth terminal module M34 are inserted into the third receiving cavity 123, all mounting block 9 is then installed in the third mounting groove 133.

Compared with the prior art, the electrical connector 100 of the present disclosure is provided with the first ground plate 151. The first ground plate 4a includes the first ground protruding portion 4a3 in contact with the first ground plate 151. With this arrangement, the present disclosure provides the electrical connector 100 with an improved grounding structure that can reduce the number of parts.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body defining a receiving slot configured to receive a mating module, the receiving slot extending along a first direction;
a first ground plate, the first ground plate being mounted to the insulating body; and
a first terminal module, the first terminal module comprising a plurality of first signal terminals and a first ground piece, the first ground piece comprising a first base portion, a plurality of first ground terminals extending from the first base portion, and a first ground protruding portion, each of the first signal terminals and the first ground terminals comprising a first elastic arm, the first elastic arm being provided with a first contact portion protruding into the receiving slot, the first contact portion being configured to be in electrical contact with the mating module;
wherein the first ground protruding portion is in contact with the first ground plate.

2. The electrical connector according to claim 1, wherein the first terminal module comprises a plurality of first cables connected to the first signal terminals.

3. The electrical connector according to claim 2, wherein the first terminal module comprises a first ground shielding piece which comprises a first shielding portion at least partially covering the first cable, a first abutting portion extending from one side of the first shielding portion and a second abutting portion extending from another side of the first shielding portion; the first abutting portion and the second abutting portion are both configured to be in contact with one side surface of the first ground piece.

4. The electrical connector according claim 3, wherein the first terminal module comprises a second ground shielding piece which comprises a first rib and a second rib, and the first rib and the second rib are both configured to be in contact with another side of the first ground piece.

5. The electrical connector according to claim 4, wherein the first terminal module comprises a first insulating block to which the first signal terminals, the first ground piece and the first ground shielding piece are at least partially fixed; the first elastic arm extends out of the first insulating block; the first ground protruding portion extends out of the first insulating block.

6. The electrical connector according to claim 5, wherein the first ground protruding portion extends out of the first insulating block along a second direction perpendicular to the first direction.

7. The electrical connector according to claim 5, wherein the second ground shielding piece defines a plurality of first positioning holes; the first insulating block comprises a plurality of first positioning posts inserted at least partially into the first positioning holes.

8. The electrical connector according to claim 1, wherein the plurality of first signal terminals comprise a first differential signal terminal and a second differential signal terminal; the first differential signal terminal and the second differential signal terminal are arranged adjacent to each other and form a first differential pair; each of two sides of the first differential pair is provided with one first ground terminal disposed adjacent to the first differential pair.

9. The electrical connector according to claim 4, further comprising a second terminal module; the second terminal module comprising a plurality of second signal terminals and a second ground piece; the second ground piece comprising a second base portion, a plurality of second ground terminals extending from the second base portion, and a second ground protruding portion; each of the second signal terminals and the second ground terminals comprising a second elastic arm; the second elastic arm being provided with a second contact portion protruding into the receiving slot; the second contact portion being configured to be in electrical contact with the mating module;
wherein the second ground protruding portion is in contact with the first ground plate.

10. The electrical connector according to claim 9, wherein the second terminal module comprises a plurality of second cables connected to the second signal terminals.

11. The electrical connector according to claim 10, wherein the second terminal module comprises a third ground shielding piece; the third ground shielding piece comprises a second shielding portion at least partially covering the second cable, a third abutting portion extending from one side of the second shielding portion and a fourth abutting portion extending from another side of the second shielding portion; the third abutting portion and the fourth abutting portion are both configured to be in contact with one side surface of the second ground piece.

12. The electrical connector according to claim 11, wherein the second terminal module comprises a fourth ground shielding piece which comprises a third rib and a fourth rib; the third rib and the fourth rib are both configured to be in contact with another side surface of the second ground piece.

13. The electrical connector according to claim 12, wherein the second terminal module comprises a second insulating block to which the second signal terminals, the second ground piece and the third ground shielding piece are at least partially fixed; the second elastic arm extends out of the second insulating block; the second ground protruding portion extends out of the second insulating block.

14. The electrical connector according to claim 13, wherein the second ground protruding portion extends out of the second insulating block in a second direction perpendicular to the first direction.

15. The electrical connector according to claim 13, wherein the fourth ground shielding piece defines a plurality of second positioning holes; the second insulating block comprises a plurality of second positioning posts inserted at least partially into the second positioning holes.

16. The electrical connector according to claim 9, wherein the plurality of second signal terminals comprise a third differential signal terminal and a fourth differential signal terminal; the third differential signal terminal and the fourth differential signal terminal are arranged adjacent to each other and form a second differential pair; each side of the second differential pair is provided with one second ground terminal disposed adjacent to the second differential pair.

17. The electrical connector according to claim 12, further comprising a first ground block disposed between the first terminal module and the second terminal module; the second ground shielding piece being in contact with one side of the first ground block, and the fourth ground shielding piece being in contact with another side of the first ground block.

18. The electrical connector according to claim 1, wherein the first ground protruding portion comprises a first straight portion, a first inclined portion, a second inclined portion, a connecting portion connecting the first straight portion and the first inclined portion, and an arc-shaped portion connecting the first inclined portion and the second inclined portion; a first included angle of 45° is formed by the first straight portion and the first inclined portion; a second included angle of 45° is formed by the first straight portion and the second inclined portion; the arc-shaped portion is provided with an arc-shaped surface that abuts against the first ground plate.

19. An electrical connector, comprising:
an insulating body, the insulating body defining a receiving slot which extends along a first direction and is configured to receive a mating module;
a first ground plate, the first ground plate comprising a first plate portion fixed in the insulating body and at least one first mounting foot extending beyond the insulating body, the at least one first mounting foot being configured to be mounted to a circuit board; and
a first terminal module, the first terminal module comprising a plurality of first signal terminals and a first ground piece, the first ground piece comprising a first base portion, a first ground protruding portion and a plurality of first ground terminals extending from the first base portion; each of the first signal terminals and the first ground terminals comprising a first elastic arm, the first elastic arm being provided with a first contact portion protruding into the receiving slot to be in electrical contact with the mating module;
wherein the first ground protruding portion elastically abuts against the first ground plate.

20. The electrical connector according to claim 19, further comprising a second terminal module; the second terminal module comprising a plurality of second signal terminals and a second ground piece; the second ground piece comprising a plurality of second ground terminals and a second ground protruding portion; each of the second signal terminals and the second ground terminals comprising a second elastic arm; the second elastic arm being provided with a second contact portion protruding into the receiving slot to be in electrical contact with the mating module;
wherein the second ground protruding portion elastically abuts against the first ground plate.
